(19) United States
(12) Patent Application Publication
(10) Pub. No.: US 2025/0113420 A1
(43) Pub. Date: Apr. 3, 2025

(54) SYSTEMS AND METHODS FOR CLOSED LOOP CONTROL

(71) Applicants: Craig Aker, Stillwater, OK (US); Jon Daniel Upton, Oklahoma City, OK (US); Jennifer Upton, Oklahoma City, OK (US); Christian Ratcliffe, Newcastle, OK (US); Brandon E. Lambert, Yukon, OK (US); Elton Lee Ledbetter, Oklahoma City, OK (US)

(72) Inventors: Craig Aker, Stillwater, OK (US); Jon Daniel Upton, Oklahoma City, OK (US); Jennifer Upton, Oklahoma City, OK (US); Christian Ratcliffe, Newcastle, OK (US); Brandon E. Lambert, Yukon, OK (US); Elton Lee Ledbetter, Oklahoma City, OK (US)

(21) Appl. No.: 18/746,398

(22) Filed: Jun. 18, 2024

Related U.S. Application Data
(60) Provisional application No. 63/525,235, filed on Jul. 6, 2023.

(51) Int. Cl. H05B 45/325; H05B 45/10; H05B 45/20

(52) U.S. Cl. CPC H05B 45/325; H05B 45/10; H05B 45/20

(57) ABSTRACT

A closed-loop current controller for regulating a current consumption of a load, comprising a current sensor for detecting a present current consumption of the load, a PWM modulator for modulating a PWM signal sent to the load and a controller for receiving an original reference signal representing a target current, the controller calculating an error signal based on a difference between the target current and the present current, the controller using an error-integrating algorithm that adjusts the original reference signal to produce a revised reference signal. The PWM modulator receives the revised reference signal and modulates the PWM signal sent to the load based in part on the revised reference signal.

This non-provisional patent application claims the benefit of U.S. Provisional Application No. 63/525,235 filed on Jul. 6, 2023, the entirety of which is incorporated herein by reference.

### FIELD

The present disclosure relates to circadian lighting. More specifically. the present disclosure relates to a system and method for closed-loop current control.

### BACKGROUND

Certain known problems can often arise in current control systems, such as lighting device systems. For example, some lighting device systems can experience transient events. Transients are sudden changes in load that can cause the current to fluctuate. There is, therefore, a general need to mitigate or compensate for these load fluctuations, ensuring that the target current is maintained.

In addition, certain lighting device systems can also experience unwanted noise in the form of random fluctuations in the current that can be caused by a number of factors, such as electrical interference. There is, therefore, a general need to filter out these types of noise, ensuring that the target current is not affected.

In addition, certain types of lighting device systems may experience a form of hysteresis, which is a phenomenon that can occur when a current controller is unable to maintain a target current. This can be caused by a number of factors, such as the accuracy of the controller or the variability of the load. There is, therefore, a general need to reduce hysteresis, ensuring that the target current is maintained more accurately.

As such, there is a general need for an apparatus, system and/or method that improves the performance of lighting device systems. For example, there is a general need for a current controller that uses an error-integrating algorithm to regulate the current consumption of a load. Such a load may comprise a lighting system, an electric motor, or other device that requires enhanced current control.

### SUMMARY

According to an exemplary arrangement, a closed-loop current controller for regulating a current consumption of a load comprising a current sensor for detecting a present current consumption of the load; a PWM modulator for modulating a PWM signal sent to the load; and a controller for receiving an original reference signal representing a target current, the controller calculating an error signal based on a difference between the target current and the present current, the controller using an error-integrating algorithm that adjusts the original reference signal to produce a revised reference signal; wherein the PWM modulator receives the revised reference signal and modulates the PWM signal sent to the load based in part on the revised reference signal.

In one arrangement, the PWM modulator modulates the PWM signal based in part on a rate of change that is limited by a maximum slew rate.

In one arrangement, the maximum slew rate is determined by a maximum allowable change rate of the PWM signal.

In one arrangement, the maximum slew rate is determined by a maximum allowable rate of change of the current consumption.

In one arrangement, the error-integrating algorithm comprises an exponential relationship between the PWM change and the current difference.

In one arrangement, the error-integrating algorithm comprises a linear relationship between the PWM change and the current difference.

In one arrangement, the error-integrating algorithm comprises a logarithmic relationship between the PWM change and the current difference.

In one arrangement, the current controller further comprising a dimming control system operating in conjunction with the current controller to provide a lighting solution.

In one arrangement, the current controller further comprising a color control system operating in conjunction with the current controller to provide a lighting solution.

In one arrangement, the load comprises a luminaire comprising at least one LED.

In one arrangement, a method for regulating the current consumption of a load, comprising the steps of detecting a present current consumption of the load using a current sensor; receiving a reference signal representing a target current; calculating an error signal based on the difference between the target current and the present current; using an error-integrating algorithm that adjusts the reference signal accordingly; and modulating a PWM signal sent to the load using a PWM modulator that receives the adjusted reference signal.

In one arrangement, the step of modulating the PWM signal comprises the step of modulating the PWM signal based on a rate of change that is limited by a maximum slew rate.

In one arrangement, the error-integrating algorithm comprises an exponential relationship between the target current and the present current.

In one arrangement, the error-integrating algorithm comprises a linear relationship between the target current and the present current.

In one arrangement, the error-integrating algorithm comprises a logarithmic relationship between the target current and the present current.

In one arrangement, the maximum slew rate is determined by the maximum allowable change rate of the PWM signal.

In one arrangement, the maximum slew rate is determined by the maximum allowable rate of change of the current consumption.

In one arrangement, a system for regulating current consumption, comprising a current sensor for detecting a present current consumption of a load; a PWM modulator for modulating a PWM signal sent to the load; a controller for receiving an original reference signal representing a target current, the controller calculating an error signal based on a difference between the target current and the present current, the controller using an error-integrating algorithm that adjusts the original reference signal to produce a revised reference signal; wherein the PWM modulator receives the revised reference signal and modulates the PWM signal sent to the load based in part on the revised reference signal; and a load connected to the PWM modulator of the current controller.

In one arrangement, the load comprises a luminaire comprising at least one LED.

In one arrangement, a lighting system comprising a dimming or color control system that works in conjunction with the current controller to provide a comprehensive lighting solution.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates an exemplary block diagram of an embodiment of a lighting system;

FIG. 2 illustrates a block diagram of a closed-loop current controller for use with a lighting system, such as the lighting system illustrated in FIG. 1; and

FIG. 3 illustrates a graph illustrating an embodiment of the PWM modulation used by the current controller.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A current controller is disclosed that uses a closed-loop control system to regulate the current consumption of a load, such as a lamp or an electric motor. The controller implements an error-integrating algorithm that modulates the pulse width modulation (PWM) signal sent to the load. The PWM signal is changed in small increments until the detected current consumption matches a target current value. The amount of change for each time period is related to the difference between the target current and the present current, and is limited by a maximum slew rate. The controller can limit both the turn-on and turn-off rates of the load by adjusting the PWM signal accordingly.

In one preferred arrangement, the closed-loop current controller is implemented as an integrating controller, such as an error integrating controller. This means that the PWM is changed a small amount per-unit-time until the detected current consumption reaches the target current. The amount that the PWM is changed for each time period is related to the difference of the target current and the present current. This relationship is currently exponentially related to the difference measurement, but could also be linear, or some other relationship. As the measured current begins to approach the target current, the calculated PWM change becomes smaller approaching 0 as the target current is reached. In one arrangement, a final slew rate limit comes in at the end of this calculation.

Once the controller calculates how much it intends to change the PWM for the time period, a final check determines if this change is larger than the allowed maximum change rate. If the calculation exceeds the maximum allowed, the PWM change may be limited to the maximum change rate. This applies to a positive difference where the present current measurement is lower than target (limits lamp turn on rate) as well as a negative difference where the present current is higher than the target (limits lamp turn off rate).

The present disclosure provides a current controller that uses an error-integrating algorithm to regulate the current consumption of a load. The controller can be used in a variety of applications, such as lighting systems, electric motors, or other device that requires enhanced current control.

In one arrangement, a current controller is disclosed that uses a closed-loop control system to regulate the current consumption of a load, such as a lamp or an electric motor. The controller implements an error-integrating algorithm that modulates the pulse width modulation (PWM) signal sent to the load. The PWM signal is changed in small increments until the detected current consumption matches a target current value. The amount of change for each time period is related to the difference between the target current and the present current and is limited by a maximum slew rate. In one arrangement, the controller can limit both the turn-on and turn-off rates of the load by adjusting the PWM signal duty cycle accordingly.

The relationship between the PWM change and the current difference can be adjusted to suit the specific application. In the present embodiment, an exponential relationship is used, but other relationships, such as linear or logarithmic, can also be implemented. As the measured current begins to approach the target current, the calculated PWM change becomes smaller, approaching 0 as the target current is reached.

To prevent abrupt changes in the PWM signal, a final slew rate limit comes in at the end of the calculation. Once the controller calculates how much it intends to change the PWM for the time period, a final check determines if this change is larger than the allowed maximum change rate. If the calculation exceeds the maximum allowed change rate, the PWM change is limited to the max change rate. This applies to a positive difference where the present current measurement is lower than target (limits lamp maximum turn on rate) as well as a negative difference where the present current is higher than the target (limits lamp maximum turn off rate).

The controller can be implemented using hardware, software, or a combination of both. It can be used in conjunction with other control systems, such as dimming or color control systems, to provide a comprehensive lighting solution.

Advantages of the present disclosure include enhanced current control, reduced power consumption, and improved load management. The error-integrating algorithm allows the controller to compensate for certain errors or fluctuations in the load, ensuring that the target current is maintained even under varying load conditions.

The present disclosure also provides a novel current controller that uses an error-integrating algorithm with slew rate limiting to regulate the current consumption of a load. The controller can be used in a variety of applications and provides improved current control and load management.

A solar event refers to a time, or range of times, that is based on a position of the sun (i.e., a solar position) at a particular location. Examples of solar events, include early morning, sunrise, mid-morning, solar noon, afternoon, sunset, evening, astronomical dawn, astronomical twilight, astronomical dusk, nautical dawn, nautical twilight, nautical dusk, civil dawn, civil twilight, civil dusk, night, and daylight. Other solar events may be defined in some embodiments.

Conventionally, lighting systems were either single-color or required complex color-programming at the source of the fixture or in an analog manner. In accordance with the present disclosure, DC tunable lighting control allows for central power control and central command control for changing light output of light fixtures to match lighting scenes based on solar events or other conditions, such as by assigning CCT and/or brightness, which may be used to maintain and/or correct circadian rhythms. Further, the present disclosure reduces the complexity for users to set-up such systems by eliminating analog programming and providing user interfaces that provide automatic and/or simplified programming.

Some luminaires (i.e., light fixtures) may provide two DC power inputs that respectively drive light sources (e.g., LEDs) in the luminaire. Such light fixtures depend on external DC power supplies to drive the two DC power inputs. These external DC power supplies may be integrated into a single unit with multiple DC power outputs, or they may be separate devices each having a single DC power output, depending on the embodiment, although a single system may use some DC power supplies with multiple outputs, and others with a single DC power output.

As referred to herein, a DC power supply refers to a portion of a device that has a separately controllable DC power output and may refer to an entire stand-alone device or may refer to a portion of a larger device with multiple functions and/or DC power outputs. Thus, a device having a single DC power output is referred to as a DC power supply, and a device having four separately controllable DC power outputs may be referred to as a first DC power supply, a second DC power supply, a third DC power supply, and a fourth DC power supply. A system according to the present disclosure includes at least one device acting as one or more DC power supplies and is connected to a power source, such as an AC power source (e.g., a 120 VAC power output driven from the AC power grid), a battery, a generator, a solar panel, or any other type or combination of types of power sources.

In some embodiments, the DC power supply provides a set voltage and varies the current based on the number of luminaires (and therefore the number of LEDs) being driven. This may be referred to as a constant voltage (CV) driver. When this approach is used, the luminaires are connected in parallel with each other and the voltage provided by the DC power supply is set based on the specifications of the luminaires. In other embodiments, the DC power supply may provide a set current and vary the voltage based on the number of luminaires (and therefore the number of LEDs) being driven. This may be referred to as a constant current (CC) driver. When this approach is used, the luminaires are connected in series and the current provided by the DC power supply is set based on the specifications of the luminaires. Such luminaires have a power output which can be connected to the next luminaire in the series and a terminator may be used to complete the circuit on the last luminaire in the series.

Brightness of an LED can be controlled by modulating the power delivered by the driver (i.e., the DC power supply) to the LED load. Because LEDs have a non-linear response to voltage, analog modulation of the voltage for dimming is not commonly used with a constant voltage driver. To dim an LED load with a constant voltage driver, the power is commonly modulated using pulse width modulation (PWM) or pulse density modulation (PDM), both of which affect the percentage of a given time period that the voltage is applied to the LED load which digitally modulates the power delivered. The time period is typically chosen to be short enough that most people cannot detect any flickering, such as 16 milliseconds (ms) or less, with the PWM or PDM modulation being performed for each time period. So, for example if a 25% brightness is desired, a PWM system may repeatedly turn the voltage on for 4 ms and then turn off the voltage for 12 ms before turning the voltage back on again and repeating. It should be noted that DC power, as the term is used herein, encompasses a PWM or PDM modulated signal, even if the voltage during the off periods goes negative, as long as substantially all of the power transfer to the LEDs is during the on periods of the PWM/PDM modulation.

While a constant current CC driver can use PWM or PDM to modulate the power delivered to the LED load, a constant current CC driver can dim the LED load by changing the DC current level delivered to the LED load, which is an analog modulation of the power delivered. This technique for dimming an LED has an advantage over PWM and PDM in that it eliminates high frequency flicker from the LEDs that can cause health issues such as migraines. Note that as the current is modulated, the voltage level may vary in a non-linear way due to the characteristics of LEDs.

The DC power supplies, as the phrase is used herein, can use various techniques to vary the amount of power delivered at their outputs, including those described herein of PWM or PDM with a constant voltage or by regulating (or modulating) the current in an analog manner. The DC power supplies have the ability to communicate with a controller through a communication interface. Various types of communications interface may be used, including, but not limited to, DMX, Ethernet, Wi-Fi, universal serial bus (USB), Digital Addressable Lighting Interface (DALI), or optical communications.

The DC power supplies may be installed with their power outputs coupled to power inputs of one or more luminaires by any type of suitable electrical cable or conductor, including, Romex® NM cable, Ethernet cable (e.g. Cat5 or Cat6 cable), individual multi-stranded or solid insulated wires, a jacketed multi-conductor cable, or another type of cabling. The conductors used should have low-enough resistance to minimize the power lost in the cable (and heat generated) and be insulated to avoid short-circuits with other cables or metal structures. Appropriate regulations such as the Uniform Electrical Code should also be followed in the selection of the cable to use to connect the DC power supplies to the luminaires and in the installation of the lighting system.

Going back to the luminaires, in some embodiments, the first power input of the luminaire is used to drive as a first set of one or more LEDs having a first spectral characteristic (i.e., light having particular spectrum of output) having a first correlated color temperature (CCT) and the second power input of the luminaire is used to drive a second set of one or more LEDs having a second spectral characteristic having a second CCT. A lighting controller (which may also be referred to as a bridge controller or virtual bridge controller) may be used to control the lighting output of one or more luminaires. The lighting controller may be communicatively coupled to two or more DC power supplies which are then electrically connected to the two DC power inputs of one or more tunable luminaires as described above. The lighting controller may be configured to understand what DC power supplies it can control and what luminaires are coupled to the DC power supplies. This configuration may be automatically performed using standard or proprietary network discovery protocols, done manually by a user, or by a combination of automatic discovery and manual configuration.

The lighting controller may then obtain profiles for the luminaires that it is able to control. The profiles may be obtained automatically during the configuration process through retrieval from a database based on information received about the luminaires, or the profiles may be manually uploaded to the lighting controller by a person (e.g., a technician) configuring the system. The profiles provide information to the lighting controller about how much power should be provided to each DC power input of the luminaire in order to achieve a particular brightness and/or CCT for that luminaire.

At various times, the lighting controller may determine that the brightness and/or CCT for a set of (one or more) luminaires connected to a pair of DC power supplies should be changed. It can use the target brightness and/or target CCT, along with the profile for the luminaires, to determine an amount of power that the two DC power supplies should provide in order to achieve the target brightness and/or target CCT and then it can send commands to the two DC power supplies to set them to deliver the calculated power to the set of luminaires.

The lighting controller may transmit signals to the two DC power supplies indicative of one or more changes in settings to produce changes in the light output from the luminaires at different times throughout the day, which may be referred to as one or more scenes. The lighting controller may transmit signals indicative of commands to the DC power supplies to send power, stop sending power, or change the amount of power sent, to produce one or more scenes that produce multiple changes in the light output from the luminaires at different times throughout the day.

The lighting controller may convert signals indicative of one or more changes in settings of the DC power supplies to DMX before transmitting the signals to the DC power supplies. However, it will be understood that the lighting controller may utilize other communication standards over any type of medium (e.g. wired, radio frequency, optical, and the like) for communications with the DC power supplies. In one embodiment, the lighting controller may transmit signals using UDP (User Datagram Protocol) or TCP (Transmission Control Protocol) to communicate through a wired network such as Ethernet or a wireless network such as Wi-Fi to control the output of the DC power supplies and to send power, stop sending power, or change the amount of power sent, to produce one or more scenes that produce multiple changes in the light output from the DC tunable luminaires at different times throughout the day. Some implementations may utilize Art-Net to transmit DMX information using UDP over Ethernet or some other network.

The change from a first scene, that is, a first CCT value and/or dimness/brightness for the light output of the luminaires, to a second scene, that is, a second CCT value and/or dimness/brightness for the light output of the luminaires, may be implemented as a step change or as a progressive change. A step change is an abrupt change that occurs from one moment to the next. A progressive change is a gradual change that takes place over time. In one embodiment, the gradual change is a series of small step changes between the beginning of the first scene and the beginning of the second scene.

For example, for the change from an early morning scene to a sunrise scene, the lighting controller may implement a step change from a 40% dim light output at a CCT having a value of 2000K to 100% brightness at 2600K at the minute of the time occurrence of sunrise. Alternatively, the lighting controller may implement a gradual change over a time period, for example 60 seconds, to change the brightness and CCT at a rate of 1% and 10K per second to make the same amount of change at the sunrise solar event. In another embodiment, the change may take place over the entire period between events, so if the early morning event occurs 60 minutes prior to the sunrise event, the lighting controller may change the brightness and CCT at a rate of 1% and 10K per minute to gradually change from 40% brightness at 2000K at the early morning event to 100% brightness at 2600K at sunrise.

The DC power supplies may receive the signal(s) indicative of the power changes and may send the indicated power to the first power input and second power input of the luminaires to produce the one or more scene. The luminaires then react by emitting the light output produced by the first LED(s) driven by the first DC power input and the second LED(s) driven by the second DC power input (either one of which may be turned off for some scenes) at the time(s) of the occurrence of the predetermined solar events and/or at predetermined times assigned for the predetermined solar events.

A lighting controller may use a profile for a tunable luminaire to compile a 24-hour program to control the tunable luminaire to have a human-centric lighting output compatible with human circadian rhythms. This program can be stored in solid state memory on a controller. The controller may be separate from or embedded within the power supply powering the luminaire. Power on/off to the fixture may be controlled by a standard single or multi pole toggle switch. When the circuit is closed, the connected light fixture produces light with the CCT and brightness as dictated by the system based on the time of day. The system can automatically adjust the CCT and brightness throughout the day for the purpose of circadian entrainment. The system may include a graphical user interface (GUI) on a user device which allows for the solar scenes to be customized for CCT and brightness. This customization may be global for an installation or unique to lighting zones within the system. The customized programming may be compiled on the user device and transferred to the controller. The default levels may remain on the controller allowing the controller to revert back to the default levels without reprogramming. The controller may have more than one set of default levels, such as constant levels that may be used before the controller is initialized, and a default human-centric cycle based on the time of day that is compatible with most people's circadian rhythm.

Existing circadian lighting systems are typically wireless and depend on network communication on both the local and wide area network, both reducing reliability. Certain existing systems offer little or no options for customization of CCT and brightness. The system disclosed herein can function normally without a network connection. A network connection may only be required if a user wants to customize scenes. The automatic, easily customized scenes and the reliability that comes from a network independent system may be factors in human-centric lighting being widely adopted.

The controller may ship with a default 24-hour program and to control connected fixtures to produce light for circadian entrainment indefinitely without additional configuration or intervention. If customization is desired, the system can also allow for that. Power level profiles may be created for human centric lights and stored in a central database accessible over the internet. Software (e.g. a mobile device app) can reference these profiles and determine the correct power levels for the connected fixtures to produce light for circadian entrainment for every minute throughout the day. The software can then create a 24-hour program for CCT and brightness for the installed fixtures and transfer the program to a controller. The controller can run the program and send commands to power supplies to send the programmed power levels to connected light fixtures to produce light of a predetermined CCT and brightness for the time of day.

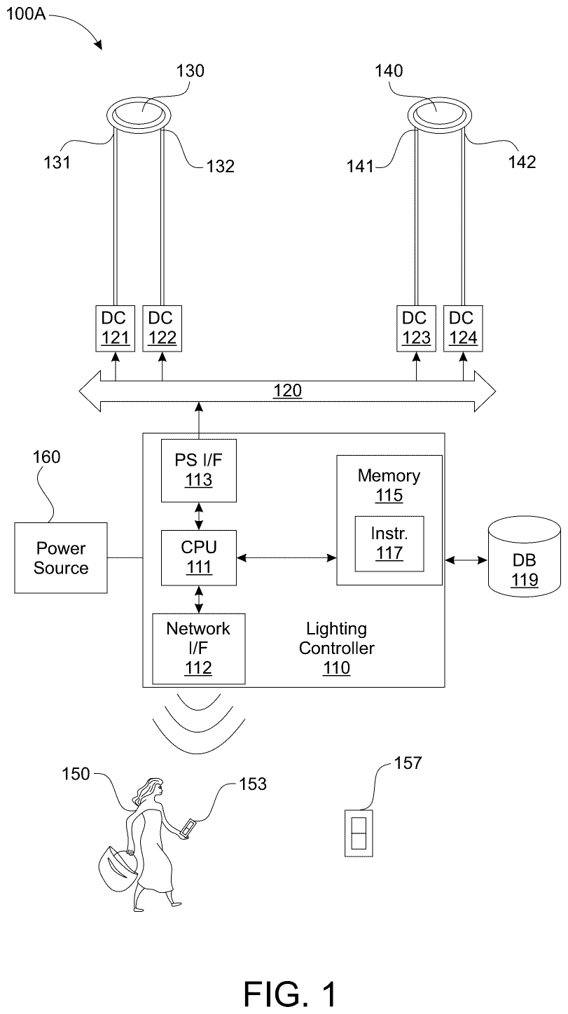

FIG. 1 illustrates a block diagram of an embodiment of a lighting system 100A. The lighting system 100A includes one or more luminaires 130 each comprising a first LED having a first spectral characteristic driven by a first direct-current (DC) power input 131 and a second LED having a second spectral characteristic driven by a second DC power input 132. Embodiments of the luminaire 130 may have any number of LEDs coupled to each of the two DC power inputs 131, 132. The lighting system 100A also includes a first DC power supply 121, separate from the one or more luminaires 130, electrically coupled to the first DC power input 131 of the one or more luminaires 130 to drive the first LEDs of the one or more luminaires 130, and a second DC power supply 122, separate from the one or more luminaires 130, electrically coupled to the second DC power input 132 of the one or more luminaires 130 to drive the second LEDs of the one or more luminaires 130. The electrical coupling of the DC power supplies 121, 122 to the DC power inputs 131, 132 of the one or more luminaires 130 can be done with any type and number of electrical conductors and/or cables.

In some embodiments, the lighting system 100A may include a second luminaire 140 that has a third set of LEDs having a third spectral characteristic coupled to a first power input 141 of the second luminaire 140 and a fourth set of LEDs having a fourth spectral characteristic coupled to a second power input 142 of the second luminaire 140. The lighting system 100A may also include a third DC power supply 123 electrically coupled to the first DC power input 141 of the second luminaire 140 to drive the third LEDs of the second luminaire 140, and a fourth DC power supply 124 electrically coupled to the second DC power input 142 of the second luminaire 140 to drive the fourth LEDs of the second luminaire 140.

The lighting system 100A also includes a lighting controller 110, communicatively coupled to the first DC power supply 121 and the second DC power supply 122 and in some embodiments to the third DC power supply 123 and fourth DC power supply 124. The lighting controller 110 is separate from the one or more luminaires 130, 140 and may be separate from the DC power supplies 121-124. The lighting controller 110 is communicatively coupled to the DC power supplies 121-124 by a communication channel 120. The communication channel 120 can be any appropriate set of unidirectional or bidirectional point-to-point communication links between the lighting controller 110 and the power supplies 121-124, including individual direct links to each power supply 121-124 from the lighting controller 110, a hierarchical tree connection channel such as USB, or a daisy-chained communication link such as DMX. The communication channel may also be a bus or network over a wired or wireless media such as, but not limited to, DALI, Ethernet, Wi-Fi, the internet, a mobile telephony network (e.g. a 3G/4G/5G network), and/or Bluetooth.

The lighting controller 110 may be a dedicated device, purpose-built to be a lighting controller, which may be referred to as a bridge controller as it provides a bridge from a user to the DC power supplies 121-124 used to control the luminaires 130, 140. In some embodiments, the lighting controller 110 may utilize a general-purpose computing device, such as a computer or a server, running software to implement the functionality of the lighting controller 110, which may be referred to as a virtual bridge controller. The lighting controller 110 may be located in the same building as the luminaires 130, 140 and be directly wired to the DC power supplies 121-124, but in some embodiments the lighting controller 110 may utilize a remote server, such as a cloud server, and communicate with the user 150 and the DC power supplies 121-124 over the internet.

The lighting controller 110 includes a processor 111 which can be any type of computing device, including, but not limited to, a 32-bit or 64-bit central processing unit (CPU) from Intel or AMD having one or more X86 architecture cores, an embedded ARM® architecture CPU with one or more cores, an 8-bit 8051 architecture processor core, a 32-bit Coldfire processor core, a RISC-V processor core, or any other processor core using any reduced instruction set computer (RISC) or complex instruction set computer (CISC) instruction set architecture having any instruction bit length. The processor 111 may also be implemented in a field-programmable gate array (FPGA) in some embodiments or using an application-specific integrated circuit (ASIC). The lighting controller includes one or more memory devices 115, such as a dynamic random-access memory (DRAM) and/or a non-volatile flash memory device, coupled to the processor 111, which can store instructions 117 for the processor 111 to perform any method disclosed herein. In some embodiments, the one or more memory devices 115 may include a user-removeable memory device, such as a Secure Digital (SD) Card or a USB drive.

The lighting controller 110 also includes a power supply control interface 113 and may optionally include a network interface 112, each coupled to the processor 111. In some embodiments, the power supply control interface 113 and the network interface 112 may be one and the same (e.g. an Ethernet interface), but in other embodiments, they may be separate interfaces (e.g. a DMX interface for the power supply control interface 113 and a Wi-Fi interface for the network interface 112). The power supply control interface 113 provides an interface to the communication link 120 used for communication with the power supplies 121-124 while the network interface 112 provides an interface to connections used to communicate with control devices such as the remote control 153 and/or the wall switch 157, as well as other electronic devices which may be used to configure and/or control the lighting system 100A. The network interface 112 may also provide the lighting controller 110 with access to the internet. Note that the wall switch 157 might not be a traditional 120 VAC switch but may simply be a device which reports the position of a switch (e.g., open or closed, or a brightness level based on a slider or knob) to the lighting controller through the network interface 112 and may not directly control any current flow to the one or more luminaires 130, 140. In some embodiments the network interface 112 may be used to communicate with the database 119, but other embodiments of the lighting controller 110 may have a dedicated interface for the database 119, such as serial attached storage interface (SATA) or small-computer serial interface (SCSI). The power supply control interface 113 and the network interface 112 can be interfaces to any appropriate communications link, including, but not limited to, DMX, DALI, Ethernet, and Wi-Fi.

The lighting controller 110 is configured to obtain a target CCT for the one or more luminaires 130, 140 and obtain a profile for the luminaire 130. The target CCT may be obtained from a user 150 using a remote control 153, a pre-defined scene associated with a solar event or a time, or from any other source. Predefined scenes, solar events, and/or times, may be stored in the memory 115, in the database 119, in a cloud server accessible over the internet, or in any other location. The profile may be stored in memory 115 or may be obtained from a database 119 based on information about the luminaire, such as a model number. The database may be embedded in the lighting controller 110, may be local with a direct connection to the lighting controller 110, or may be remote, such as being hosted by a cloud server or a web server accessible to the lighting controller 110 over the internet. In other embodiments, the profile may be provided by a technician during a configuration of the lighting system 100A.

The lighting controller 110 is further configured to calculate a first target power for the first DC power input 131 of the luminaire 130 and a second target power for a second DC power input 132 of the luminaire 130 based on the target CCT and the profile. The first target power and the second target power are calculated to drive the luminaire 130 to emit light at the target CCT. The lighting controller 130 is also configured to control the first DC power supply 121 to deliver the first target power to the first DC power input 131 of the luminaire 130 and the second DC power supply 122 to deliver the second target power to the second DC power input 132 of the luminaire 130. The lighting controller 110 can control the DC power supplies 121, 122 by sending commands over the communication link 120 to the DC power supplies 121, 122.

In embodiments that include the second luminaire 140 driven by the third and fourth DC power supplies 123, 124, the lighting controller 110 is configured to obtain a second profile, different than the first profile, for the second luminaire 140 and to calculate a third target power for a first DC power input 141 of the second luminaire 140 and a fourth target power for a second DC power input 142 of the second luminaire 140 based on the target CCT and the second profile. The third target power and the fourth target power are calculated to drive the second luminaire 140 to emit light at the target CCT. Note that because the first luminaire 130 may have different characteristics than the second luminaire 140, the first and second target power may be different than the third and fourth target power but still allow both the first luminaire 130 and the second luminaire 140 to emit light at the target CCT and brightness. Once the third power target and the fourth power target have been calculated, the lighting controller 110 may be configured to control the third DC power supply 123 to deliver the third target power to the first DC power input 141 of the second luminaire 140 and a fourth DC power supply 124 to deliver the fourth target power to the second DC power input 142 of the second luminaire 140.

Note that the lighting controller 110 may be able to fully function without the use of the network interface 112 by using default scenes built into the controller 110 and stored in the memory 115. Thus, embodiments without a network interface 112 are possible. Some embodiments may function in a default mode but still include a network interface 112 to allow a user 150 to optionally customize its scenes.

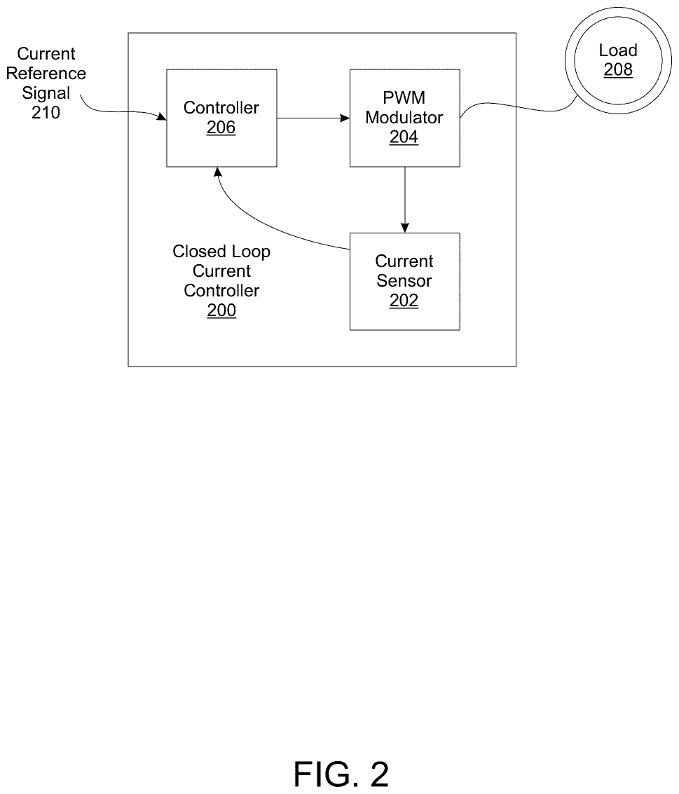

FIG. 2 illustrates a block diagram of a closed-loop current controller for use with a lighting system, such as the lighting system 100A illustrated in FIG. 1. Such a closed-loop current controller may comprise a direct current controller such as the direct current controllers 121, 122, 123 and 124 as illustrated in FIG. 1. More specifically, FIG. 2 illustrates an embodiment of a closed-loop current controller 200 for regulating the current consumption of a load, such as the luminaires 130, 140 illustrated in FIG. 1.

In this illustrated arrangement of FIG. 2, the block diagram illustrates the main components of the closed loop current controller 200, including a current sensor 202, a PWM modulator 204, and a controller 206. The current sensor 202 detects the present current consumption of the load 208 (e.g., the luminaires 230 and 240 of FIG. 1). In addition, the PWM modulator 204 modulates the PWM signal sent to the load 208.

The controller 206 receives a reference signal 210 representing the target current. And based on this reference signal 210, the controller 206 calculates an error signal based on a difference between the target current and the present current. In one arrangement, the controller 206 then adjusts the reference signal accordingly using an error-integrating algorithm.

This adjusted reference signal is then sent to the PWM modulator 204, which modulates or modifies the PWM signal sent to the load 208 based in part on a rate of change that is limited by a maximum slew rate. As this term is used herein, the maximum slew rate applied by the PWM modulator 204 is the maximum rate at which the PWM signal can change with respect to the PWM duty cycle. As just one example, the maximum slew rate may be expressed in percent per second.

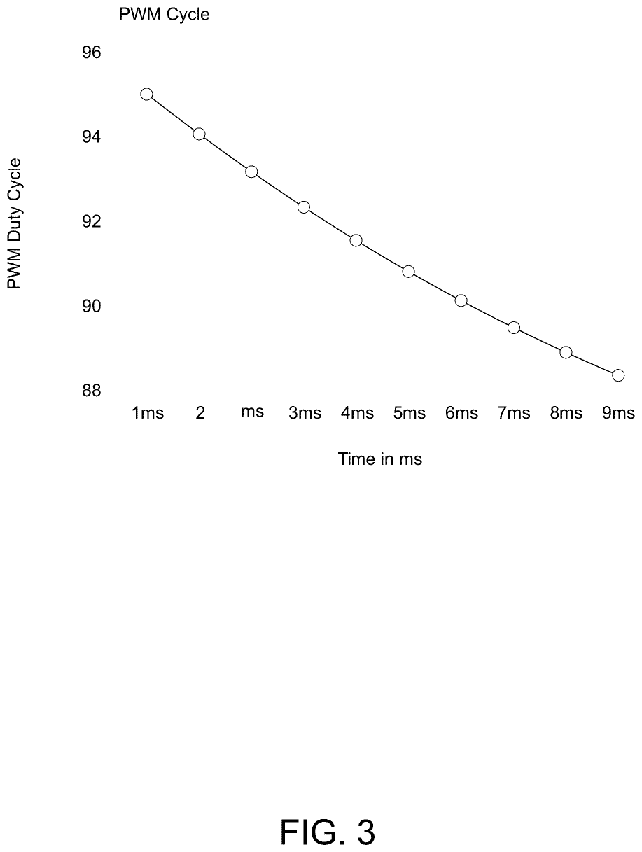

FIG. 3 illustrates a graph illustrating an embodiment of the PWM modulation used by the current controller. The graph shows the PWM signal sent to the load over time, with the horizontal axis representing Time in ms and the vertical axis representing the PWM signal duty cycle. As used herein, the PWM modulator 204 as illustrated in FIG. 2 can limit both the turn-on and turn-off rates of the load by adjusting the duty cycle of the applied PWM. The duty cycle is the percentage of the time that the PWM signal is high. A lower duty cycle means that the PWM signal is off for a longer period of time.

When the PWM signal is turned on, the load will start to turn on. The rate at which the load turns on will depend on the duty cycle of the PWM signal. A lower duty cycle will mean that the load turns on more slowly. When the PWM signal is turned off, the load will start to turn off. The rate at which the load turns off will also depend on the duty cycle of the PWM signal. A lower duty cycle will mean that the load turns off more slowly. By adjusting the duty cycle of the PWM signal, the PWM controller can limit both the turn-on and turn-off rates of the load.

The graph illustrates the gradual increase or decrease of the PWM signal duty cycle as the controller detects a difference between the target current and the present current, with the rate of change limited by a maximum slew rate. As the measured current approaches the target current, the rate of change slows down until the PWM signal stabilizes at the desired duty cycle, which represents the target current. In this example, the measured current was more than the target current. Therefore, the duty cycle of the PWM was reduced from an initial duty cycle of 95% to a final duty cycle of about 88%. As the PWM was incrementally reduced, these reductions can be implemented so that each incremental change did not exceed the maximum slew rate of 1% per millisecond resulting in a final transition period of 9 ms.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

We claim:

1. A closed-loop current controller for regulating a current consumption of a load, comprising:
a current sensor for detecting a present current consumption of the load;
a PWM modulator for modulating a PWM signal sent to the load; and
a controller for receiving an original reference signal representing a target current, the controller calculating an error signal based on a difference between the target current and the present current, the controller using an error-integrating algorithm that adjusts the original reference signal to produce a revised reference signal;
wherein the PWM modulator receives the revised reference signal and modulates the PWM signal sent to the load based in part on the revised reference signal.

2. The controller of claim 1, wherein the PWM modulator modulates the PWM signal based in part on a rate of change that is limited by a maximum slew rate.

3. The current controller of claim 2, wherein the maximum slew rate is determined by a maximum allowable change rate of the PWM signal.

4. The current controller of claim 2, wherein the maximum slew rate is determined by a maximum allowable rate of change of the current consumption.

5. The current controller of claim 1, wherein the error-integrating algorithm comprises an exponential relationship between the PWM change and the current difference.

6. The current controller of claim 1, wherein the error-integrating algorithm comprises a linear relationship between the PWM change and the current difference.

7. The current controller of claim 1, wherein the error-integrating algorithm comprises a logarithmic relationship between the PWM change and the current difference.

8. The current controller of claim 1, further comprising a dimming control system operating in conjunction with the current controller to provide a lighting solution.

9. The current controller of claim 1, further comprising a color control system operating in conjunction with the current controller to provide a lighting solution.

10. The current controller of claim 1 wherein the load comprises a luminaire comprising at least one LED.

11. A method for regulating the current consumption of a load, comprising the steps of:
detecting a present current consumption of the load using a current sensor;
receiving a reference signal representing a target current;
calculating an error signal based on the difference between the target current and the present current;
using an error-integrating algorithm that adjusts the reference signal accordingly; and
modulating a PWM signal sent to the load using a PWM modulator that receives the adjusted reference signal.

12. The method of claim 11, wherein the step of modulating the PWM signal comprises the step of modulating the PWM signal based on a rate of change that is limited by a maximum slew rate.

13. The method of claim 11, wherein the error-integrating algorithm comprises an exponential relationship between the target current and the present current.

14. The method of claim 11, wherein the error-integrating algorithm comprises a linear relationship between the target current and the present current.

15. The method of claim 11, wherein the error-integrating algorithm comprises a logarithmic relationship between the target current and the present current.

16. The method of claim 11, wherein the maximum slew rate is determined by the maximum allowable change rate of the PWM signal.

17. The method of claim 12, wherein the maximum slew rate is determined by the maximum allowable rate of change of the current consumption.

18. A system for regulating current consumption, comprising:
a current sensor for detecting a present current consumption of a load;
a PWM modulator for modulating a PWM signal sent to the load;
a controller for receiving an original reference signal representing a target current, the controller calculating an error signal based on a difference between the target current and the present current, the controller using an error-integrating algorithm that adjusts the original reference signal to produce a revised reference signal;
wherein the PWM modulator receives the revised reference signal and modulates the PWM signal sent to the load based in part on the revised reference signal; and
a load connected to the PWM modulator of the current controller.

19. The system of claim 18 wherein the load comprises a luminaire comprising at least one LED.

20. A lighting system comprising the system of claim 18 further comprising a dimming or color control system that works in conjunction with the current controller to provide a comprehensive lighting solution.
